(19) United States
(12) Patent Application Publication
(10) Pub. No.: US 2009/0177373 A1
(43) Pub. Date: Jul. 9, 2009

(54) Navigation device and method

(76) Inventors: Lucien Groenhuijzen, Almere (NL); Ralf-Peter Schaefer, Berlin (DE); Nick Cohn, Amsterdam (NL); Stefan Lorkowski, Berlin (DE); Peter Mieth, Berlin (DE); Rob Schuurbiers, Amsterdam (NL)

Correspondence Address: TOMTOM INTERNATIONAL B.V., REMBRANDTPLEIN 35., AMSTERDAM, 1017CT, NL

(21) Appl. No.: 12/007,135

(22) Filed: Jan. 7, 2008

(51) Int. Cl. G08G 1/00

(52) U.S. Cl. 701/117

(57) ABSTRACT

A method of providing a graphical indication of traffic congestion along a stretch of physical road notionally divided by a traffic information provider into one or more road segments is disclosed. The invention also covers a navigation system, portable navigation device, and or software capable of implementing such a method.

### BACKGROUND OF THE INVENTION

Portable navigation devices (PNDs) including GPS (Global Positioning System) signal reception and processing means are well known and are widely employed as in-car navigation systems. In essence, modern PNDs comprise:
a processor,
memory (at least one of volatile and non-volatile, and commonly both),
map data stored within said memory,
a software operating system and optionally one or more additional programs executing thereon, to control the functionality of the device and provide various features,
a GPS antenna by which satellite-broadcast signals including location data can be received and subsequently processed to determine a current location of the device,
optionally, electronic gyroscopes and accelerometers which produce signals capable of being processed to determine the current angular and linear acceleration, and in turn, and in conjunction with location information derived from the GPS signal, velocity and relative displacement of the device and thus the vehicle in which it is mounted,
input and output means, examples including a visual display (which may be touch sensitive to allow for user input), one or more physical buttons to control on/off operation or other features of the device, a speaker for audible output,
optionally one or more physical connectors by means of which power and optionally one or more data signals can be transmitted to and received from the device, and
optionally one or more wireless transmitters/receivers to allow communication over mobile telecommunications and other signal and data networks, for example Wi-Fi, Wi-Max GSM and the like.

The utility of the PND is manifested primarily in its ability to determine a route between a start or current location and a destination, which can be input by a user of the computing device, by any of a wide variety of different methods, for example by postcode, street name and number, and previously stored well known, favorite or recently visited destinations. Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice. In addition, the device may continually monitor road and traffic conditions, and offer to or choose to change the route over which the remainder of the journey is to be made due to changed conditions. Real time traffic monitoring systems, based on various technologies (e.g. mobile phone calls, fixed cameras, GPS fleet tracking) are being used to identify traffic delays and to feed the information into notification systems.

The navigation device may typically be mounted on the dashboard of a vehicle, but may also be formed as part of an on-board computer of the vehicle or car radio. The navigation device may also be (part of) a hand-held system, such as a PDA (Personal Navigation Device) a media player, a mobile phone or the like, and in these cases, the normal functionality of the hand-held system is extended by means of the installation of software on the device to perform both route calculation and navigation along a calculated route. In any event, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function provided, and the navigation along such a route is another primary function. During navigation along a calculated route, the PND provides visual and/or audible instructions to guide the user along a chosen route to the end of that route, that is the desired destination. It is usual for PNDs to display map information on-screen during the navigation, such information regularly being updated on-screen so that the map information displayed is representative of the current location of the device, and thus of the user or user's vehicle if the device is being used for in-car navigation. An icon displayed on-screen typically denotes the current device location, and is centred with the map information of current and surrounding roads and other map features being also displayed. Additionally, navigation information may be displayed, optionally in a status bar above, below or to one side of the displayed map information, examples of navigation information including the distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that
a user deviates from the previously calculated route during navigation therealong,
real-time traffic conditions dictate that an alternative route would be more expedient and the device is suitably enabled to recognize such conditions automatically, or
if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Regardless of whether the device is operating in a navigation mode or a free driving mode, if the display of traffic information is enabled on the device, particular segments of the current road, future roads in a planned route, or roads in the vicinity of the current road, represented graphically on the display of the device, may be appropriately graphically emphasized, identified by, or overlaid with one or more icons, linear indicators or other graphics representative of traffic congestion. This allows a user, particularly when the device provides an overview display of a calculated route, to quickly determine the prevailing traffic conditions along his route, and whether these are likely to give rise to significant delays.

Of course, wirelessly received traffic information has been available for many years, for example as part of the RDS-TMC (radio data system—traffic message channel) and more recently over wireless/mobile telecommunications networks. The quality and detail provided of such data has also been increasing in recent years, and it is now possible to receive information describing particular levels of traffic congestion on a particular segment of a road, and to derive from this the absolute and relative speeds of vehicles in the particular road segment concerned.

PNDs and navigation systems of the prior art are known which are capable of receiving such traffic data and graphically presenting such in different forms, for example as different coloured icons with each colour representing traffic congestion of increasing severity on particular road segments. Thus, a plurality of traffic data relating to a plurality of different road segments is received, decoded and stored, together with some location identifier substantially corresponding to the middle of the segment of road defined in the map data to which that data relates. In one prior art traffic information display method, one or more icons are optionally resized and displayed, together with the map information, in the appropriate location identified in the map data so that the icons appear to coincide with the segments of the road on which traffic congestion is prevailing. The colour or appearance of the icons may be different to represent traffic conditions of differing in severity.

An alternative prior art method of representing traffic congestion graphically is to overlay or combine one or more elongate coloured bitmaps or other image types, appropriately sized to match the segments of roads to which they relate, with the map data so that the graphically displayed road has one or more coloured blocks representative of particular road segments on which traffic congestion is prevailing. Again, different colours may be used to convey different levels of severity of the traffic congestion, for example standing traffic, very slow traffic, slow traffic and the like. Of course, no such bitmap is displayed on screen for segments of the road along which there is no congestion. For roads which are busy therefore, the graphical display often appears with a many differently coloured blocks adjacent one another to represent that different segments of the road have different levels of congestion along a particular stretch.

An alternative prior art system combines the above technique with an averaging technique over particular stretches of road along which various levels of congestion have been identified, and uses bitmaps of only a single colour to signify the existence of congestion, but not its severity. For any particular stretch of road, either the calculated average congestion level is below a threshold, in which case no bitmap is displayed, or it is above that threshold, in which case a bitmap is displayed. Consecutive segments of a road in which the traffic congestion is above a predetermined threshold level therefore appeared “filled in” on the display, and other segments appear normally displayed.

While such indications of traffic congestion are useful to a certain degree, the main disadvantage with the various methods is the graphics do not instantly inform the user of the overall severity of, and likely transit time and/or speed through, the various differently congested segments of a stretch of road. In the first case where icons are displayed, and in the second case where differently coloured bitmaps are used, the only information conveyed to the user is that either a stretch of road is only lightly congested or it is more heavily congested in a number of different segments thereof. In the latter case, where only a single colour bitmap or other graphic is used, an aggregate calculation is performed by the PND, and the information conveyed to the user is that one or more consecutive segments of a road are congested to some degree, but there is no indication of the particular level of congestion.

In the real world, traffic congestion is a highly fluid characteristic, and the graphical representation thereof, as achieved by the methods above, is an understandably crude approximation to the actual traffic conditions.

As the reader will be aware, current traffic levels, certainly on Western European roads, are so severe that congestion tends to arise, to varying degrees, along lengthy stretches of roads with a resulting stop-start traffic motion. In these cases, users of navigation devices are more concerned not with whether different segments of the stretch of road are congested to different degrees, or the proportion of particular stretches of roads which are congested to any degree, but more with the likely average speed which might be achieved through, or the likely overall time delay which might be experienced as a result of, the congestion. Additionally, some graphical indication of the severity of the congestion is still of informational value to the user, and therefore it is an object of this invention to provide a method, a PND, and/or a navigation system which is adapted to display enhanced graphical indications representative of traffic congestion in a useful manner and thus overcome the described disadvantages.

### BRIEF SUMMARY OF THE INVENTION

According to the present invention there is provided a method of providing a graphical indication of traffic congestion along a stretch of physical road notionally divided by a traffic information provider into one or more road segments,

Characterized in by the steps of

determining that stop-start type traffic congestion exists by analyzing the traffic information received for each of a plurality of adjacent or proximate road segments and identifying that different traffic congestion severities prevail therein, determining an aggregated traffic congestion value for some or all of said plurality of segments and comparing that value to a first threshold value, a positive comparison result therewith being indicative of a level of congestion for said segments which should be identified to a user graphically,

determining a measure of the relative density of segments within said plurality of segments for which the aggregated traffic congestion value does not result in a positive comparison, and displaying one of a plurality of different graphical indicators repeatedly for all said plurality of segments, the particular graphical indicator being dependent on said determination, and thus providing an indication of both the relative overall severity of traffic congestion in said plurality of segments, and that a stop-start type of traffic congestion prevails along the stretch of road comprised of said plurality of segments.

Preferably, the graphical indicator is different from the graphical indicators used to represent different traffic congestion severities, such being derived directly from traffic information received for individual road segments, and preferably such are also capable of being displayed where the method above determines that no stop-start traffic conditions exist.

Most preferably, the graphical indicators are representative of one of average speed or the likely transit or delay time throughout the plurality of segments, the calculation of such standard parameters being based on the traffic information received and the overall physical length of the stretch of road comprised of said plurality of segments.

Most preferably, only a single graphical indicator is used for the stretch of road on which different severities of traffic congestion prevail so that a user can immediately understand that the congestion is of a start-stop nature, and also one of
the time delay relative to the time it would usually take to travel along that stretch of road when uncongested, that is either a calculated or stored usual travel time, such optionally being calculated from map data including indications of the speed limit or limits for different portions of the stretch of road,
a calculated average speed of travel along the stretch of road.
a calculated time of travel along the stretch of road.

In further aspects of the invention, a computer program, embodied on computer readable media as required, is provided for implementing the methods described above, as is a PND and/or navigation system adapted to perform the methods described.

### BRIEF DESCRIPTION OF THE DRAWINGS

The present application will be described in more detail below by using example embodiments, which will be explained with the aid of the drawings, in which:

FIG. 1 illustrates an example view of a Global Positioning System (GPS);

FIG. 2 illustrates an example block diagram of electronic components of a navigation device;

FIG. 3 illustrates an example block diagram of the manner in which a navigation device may receive information over a wireless communication channel;

FIGS. 4A and 4B are perspective views of an implementation of an embodiment of the navigation device;

FIG. 5 shows a graph and graphical linear representation demonstrating one prior art method of representing traffic information graphically,

FIG. 6 shows a second graphical linear representation demonstrating a second prior art method of graphically representing received traffic information, and

FIG. 7 shows a method according to the present invention of graphically representing traffic information.

### DETAILED DESCRIPTION OF THE INVENTION

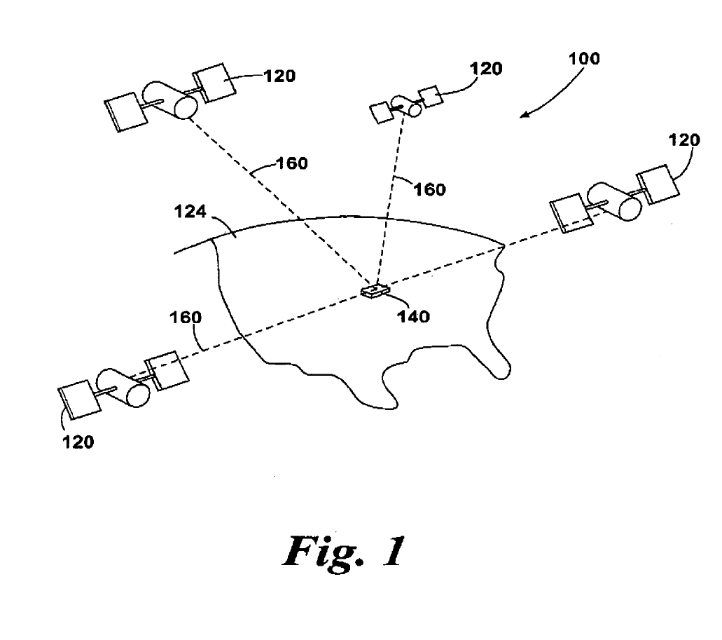

FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which work with the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

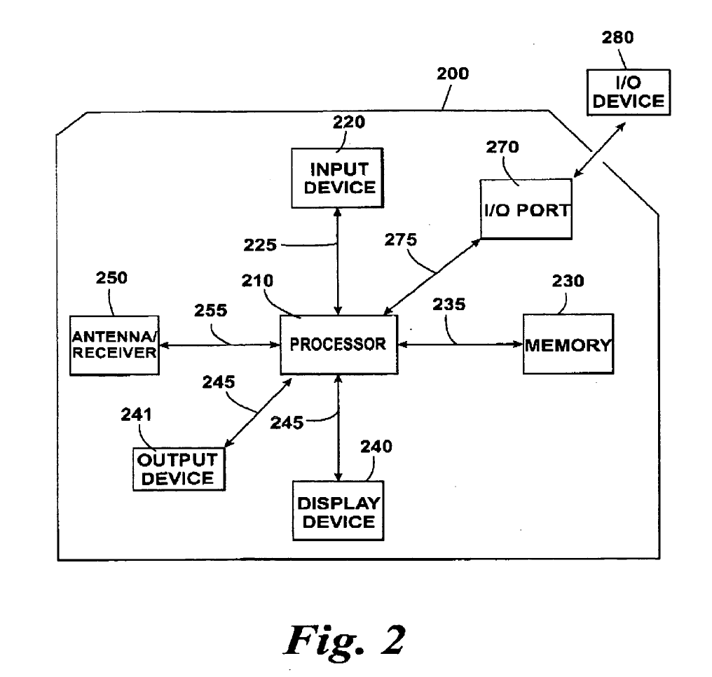

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner. FIG. 2 illustrates an example block diagram of electronic components of a navigation device 200, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilized to input information; and the display screen 240 can include any type of display screen such as an LCD display, for example. The input device 220 and display screen 240 are integrated into an integrated input and display device, including a touchpad or touchscreen input wherein a user need only touch a portion of the display screen 240 to select one of a plurality of display choices or to activate one of a plurality of virtual buttons.

In addition, other types of output devices 250 can also include, including but not limited to, an audible output device. As output device 241 can produce audible information to a user of the navigation device 200, it is equally understood that input device 240 can also include a microphone and software for receiving input voice commands as well. In the navigation device 200, processor 210 is operatively connected to and set to receive input information from input device 240 via a connection 225, and operatively connected to at least one of display screen 240 and output device 241, via output connections 245, to output information thereto. Further, the processor 210 is operatively connected to memory 230 via connection 235 and is further adapted to receive/send information from/to input/output (I/O) ports 270 via connection 275, wherein the I/O port 270 is connectable to an I/O device 280 external to the navigation device 200. The external I/O device 270 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

The navigation device 200 may establish a “mobile” or telecommunications network connection with the server 302 via a mobile device 400 (such as a mobile phone, PDA, and/or any device with mobile phone technology) establishing a digital connection (such as a digital connection via known Bluetooth technology for example). Thereafter, through its network service provider, the mobile device 400 can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device 400 (via a service provider) and another device such as the server 302, using the internet 410 for example, can be done in a known manner. This can include use of TCP/IP layered protocol for example. The mobile device 400 can utilize any number of communication standards such as CDMA, GSM, WAN, etc.

As such, an internet connection may be utilized which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet.

The navigation device 200 can further complete a data connection with the mobile device 400, and eventually with the internet 410 and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, wherein the internal antenna of the navigation device 200 can further alternatively be used). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet 410 for example, in a manner similar to that of any mobile device 400.

For GRPS phone settings, the Bluetooth enabled device may be used to correctly work with the ever changing spectrum of mobile phone models, manufacturers, etc., model/manufacturer specific settings may be stored on the navigation device 200 for example. The data stored for this information can be updated.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a motorized vehicle such as a car or boat for example. Such a navigation device 200 is then removable from the docked location for portable or handheld navigation use.

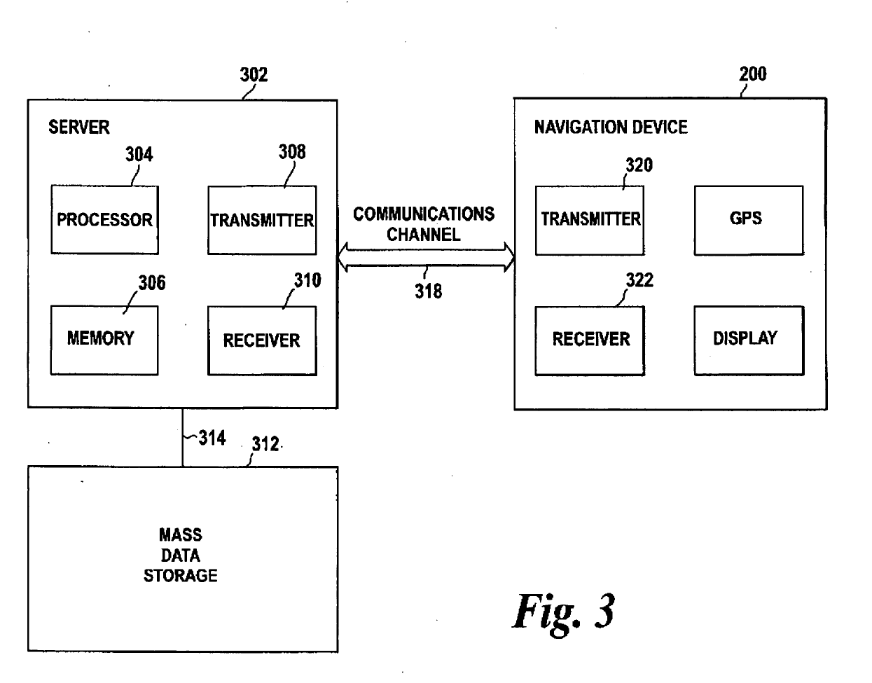

FIG. 3 illustrates an example block diagram of a server 302 and a navigation device 200 capable of communicating via a generic communications channel 318. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver. Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fiber optic cables, converters, radio-frequency (rf) waves, the atmosphere, empty space, etc. Furthermore, the communication channel 318 can include intermediate devices such as routers, repeaters, buffers, transmitters, and receivers, for example.

For example, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

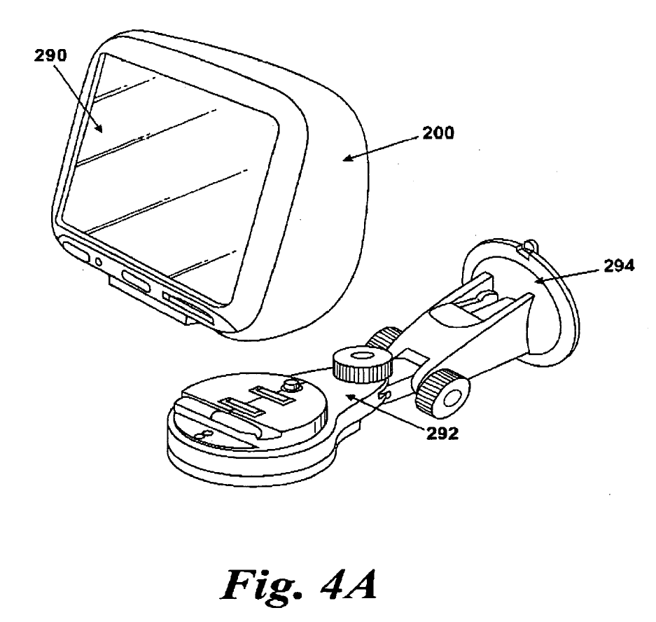

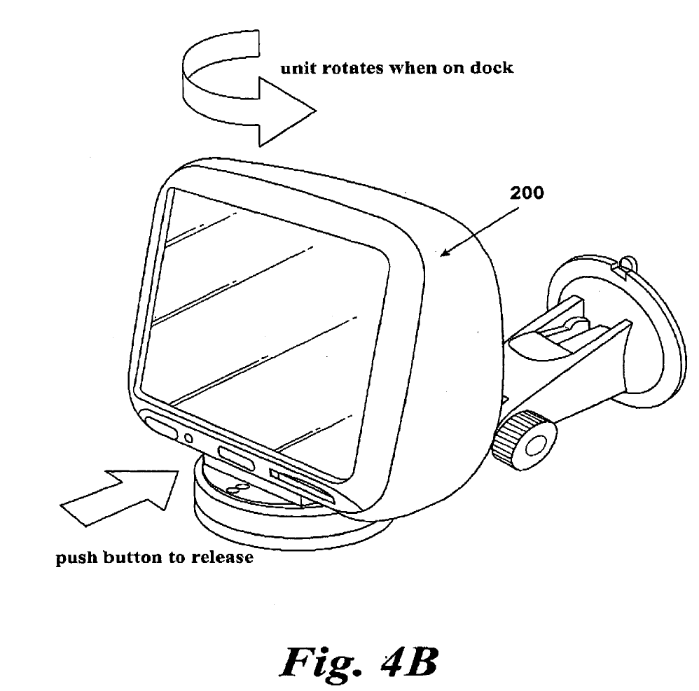

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 220, etc.).

The navigation device 200 may sit on an arm 292, which itself may be secured to a vehicle dashboard/window/etc. using a large suction cup 294. This arm 292 is one example of a docking station to which the navigation device 200 can be docked. As shown in FIG. 4B, the navigation device 200 can be docked or otherwise connected to an arm 292 of the docking station by snap connecting the navigation device 292 to the arm 292 for example (this is only one example, as other known alternatives for connection to a docking station are within the scope of the present application). The navigation device 200 may then be rotatable on the arm 292, as shown by the arrow of FIG. 4B. To release the connection between the navigation device 200 and the docking station, a button on the navigation device 200 may be pressed, for example (this is only one example, as other known alternatives for disconnection to a docking station are within the scope of the present application).

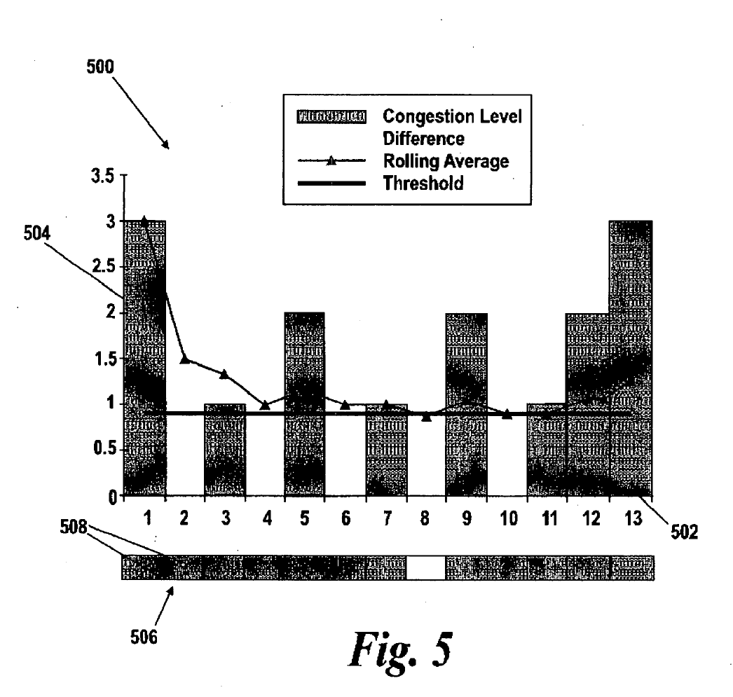

Referring now to FIG. 5, there is shown a graphical representation of traffic information, indicated generally at 500, received wirelessly or otherwise by the device and stored in memory, and specific to 13 adjacent physical segments of road identified along the x-axis of the graph, 502. The severity of traffic congestion is shown along the y-axis 504. For each of the x- and y-axes, the numbers are purely representative, and more specific information may be stored in memory, for example specific geographical coordinates, lengths and/or specific road indicators for the various road segments, and more detailed numerical or alphanumerical data describing the actual severity of the traffic congestion for any particular segment. However, for the purposes of the invention, this information presented in the graph will be sufficient.

As can be seen from the graph, the solid columns represent different traffic congestion levels for different segments of road. The horizontal line represents some predetermined threshold stored in the memory of the device, and the varyingly inclining and declining line represents a moving average of the traffic congestion over the stretch of physical road represented by the 13 segments. Thus, if the nominal length of each road segment is unitary, the average traffic congestion is 3 within the first segment, (3+0)/2, that is 1.5 for segments 1 and 2, (3+0+1)/3=1.333 for segments 1, 2 and 3, and so on.

In the same manner that it can be immediately appreciated from a visual inspection of the graph that the traffic congestion is intermittent and of varying differing levels of severity, the PND or navigation system can also make an assessment that the traffic congestion for the stretch of road is of a stop-start nature.

In one prior art method, an aggregation method is used, such as a rolling average as illustrated, a basic average (e.g. (3+0+1+0+2+0+1+0+2+0+1+2+3)/13=1.154) or any other suitable mathematical function, to derive some measure of the traffic congestion level over the entire stretch of road. In the instance, for any segment, that the averaged value diminishes below the threshold value, e.g. in segment 8, the PND does not display a traffic congestion graphic indicator for this segment of the road as it appears on the display of the device.

Thus, although simplistic, the linear representation 506 is indicative of the manner in which traffic information can be represented graphically on a PND or navigation system display screen. It is of course to be understood that the straight linear format is unlikely as the display of roads on screen typically includes a variety of bends and straight portions. Thus, for each of segments 1-7, and 9-13, the rolling average value of traffic congestion is above the threshold value, and therefore the PND causes the display of a suitably sized graphical indicator, such as a simple block of colour, within the demarcation lines of the road as they appear on the screen of the device. In the prior art method, the colour is uniform for those segments where it is desired to represent the existence of traffic information, and no graphical indicator is used for segment 8, where it is determined that the traffic congestion level is below the threshold for display.

Accordingly, a user of the PND device looking at the display screen showing graphical map data in which a road is represented and additionally marked as described above can appreciate that there is a significant congestion along the length of road represented by segments 1-7, a brief respite from the congestion in segment 8, and more congestion within segments 9-13. However, there is no indication of the nature of the congestion or its severity using this method of traffic information representation.

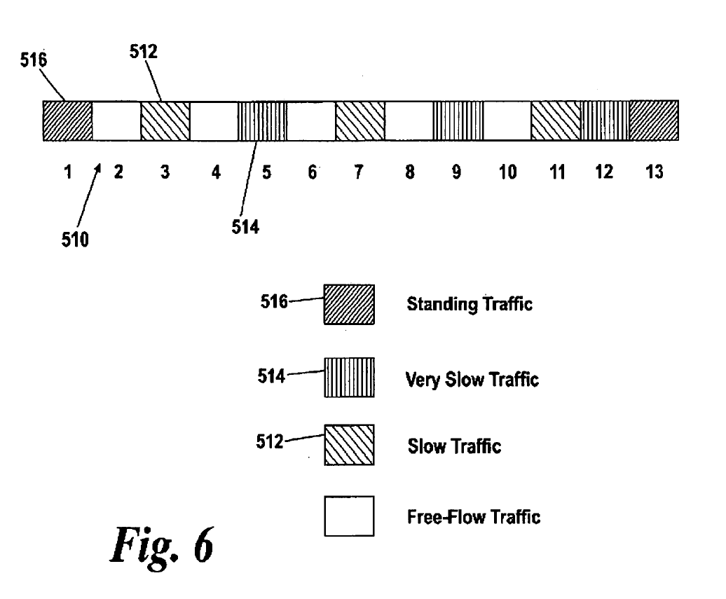

An alternative method representing traffic information is shown in FIG. 6, in which a linear representation 510 is provided and graphically or virtually (i.e. in the memory of the device or system) divided into segments of physical road which comprise the overall stretch of road and for which traffic information is received. In this prior art method, the graphical indicators 512, 514, 516, are different and correspond directly to the particular traffic congestion levels indicated in the received traffic information for each individual segment of road. Thus in this method of display, the traffic congestion is immediately recognizable as being intermittent (no graphical indicators being used given for segments 2, 4, 6, 8, 10 and different indicators being used to signify different levels of congestion), but the user cannot easily establish from such a representation the overall severity of congestion or the likely time delay or average speed along the stretch of road represented.

Incidentally, it is worth mentioning that, in this case, no traffic congestion is prevailing for segments of road preceding or following segments 1-13 shown in the figures, and either this is as a result of no traffic information having been received for such segments, or that information which has been received indicates that there is no or very little congestion on such segments.

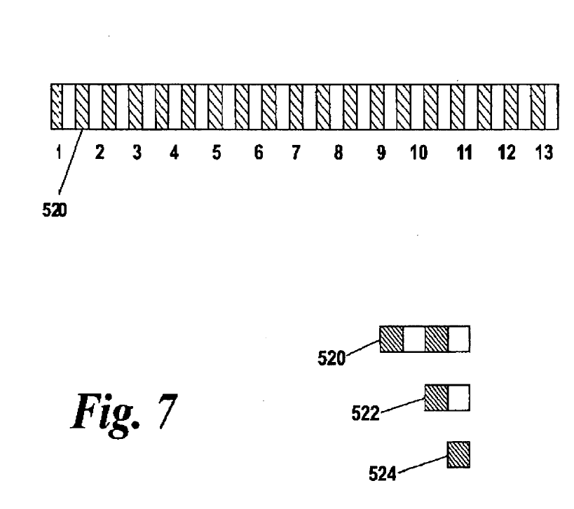

Referring now to FIG. 7, and in accordance with the invention, there is shown a further linear representation 520 representing road segments 1-13, filled in uniform manner and entirely along the stretch of road represented by said segments, with graphical indicators, being one or more of the specific indicators 520, 522, 524. Of course other indicators are possible, but their graphical display and juxtaposition within the demarcators of the road should be such that a uniform fill structure is achieved.

Although only one colour of indicator is represented in FIG. 7, other colours are possible to immediately indicate to a user that
start-stop type traffic congestion prevails along the entire stretch of road represented by the segments, and
a specific measure or severity of this type of traffic congestion is additionally indicated, for instance by providing a legend of some description on the screen of the device or in memory and accessible for display on user-selection of one or more device option functions.

The legend or key may provide an indication of average speed of travel, expected time delay relative to travel along the uncongested road, or the likely time for travel along the stretch of road, and although the specific information relating to speed or time may not be displayed on screen, it is party of the invention that the PND or system is capable of displaying a plurality of different types of graphical indicator representing stop-start traffic congestion of different severities, aggregated or otherwise averaged as the case may be along the particular stretch of road.

1. A method of providing a graphical indication of traffic congestion along a stretch of physical road notionally divided by a traffic information provider into one or more road segments, the method comprising the steps of:
determining that stop-start type traffic congestion exists by analyzing traffic information received for each of a plurality of adjacent or proximate road segments and identifying that different traffic congestion severities prevail therein,
determining an aggregated traffic congestion value for some or all of said plurality of segments and comparing that value to a first threshold value, a positive comparison result therewith being indicative of a level of congestion for said segments which should be identified to a user graphically,
determining a measure of relative density of segments within said plurality of segments for which said aggregated traffic congestion value does not result in a positive comparison, and
displaying one of a plurality of different graphical indicators repeatedly for all said plurality of segments, a particular graphical indicator being dependent on said determination, and thus providing an indication of both relative overall severity of traffic congestion in said plurality of segments, and that a stop-start type of traffic congestion prevails along the stretch of road comprised of said plurality of segments.

2. The method according to claim 1, further comprising the steps of using said graphical indicator to represent stop-start type traffic congestion, said graphical indicator being is different from other graphical indicators used to represent different non-start-stop type traffic congestion severities.

3. The method according to claim 1, wherein the graphical indicators are representative of one of average speed, approximate transit time and approximate relative delay time throughout said plurality of road segments which constitute a stretch of road on which stop-start type traffic congestion prevails.

4. The method according to claim 1, further comprising the step of using a single graphical indicator for a stretch of road on which different severities of traffic congestion prevail so as to represent to a user that congestion is of a start-stop nature, and at least one of the following:
a time delay relative to a time it would usually take to travel along that stretch of road when uncongested, that is either a calculated or stored usual travel time, such optionally being calculated from map data including indications of a speed limit or limits for different portions of said stretch of road,
a calculated average speed of travel along the stretch of road, and
a calculated time of travel along the stretch of road.

5. The method according to claim 4, further comprising the step of using a plurality of different graphical indicators, each being representative of a different level of severity of a stop-start traffic congestion condition, and thus of a different time delay, travel time or average speed along a stretch of road for which traffic information is received for individual segments of road therein.

6. A method according to claim 4 wherein the method further comprises the steps of displaying a legend, either during map information display or outside of map information display, via user selection of one or more user-selectable option icons displayed during map information display, such that said legend comprises different graphical indicators displayed together with an indication of the time delay, travel time or average speed represented thereby.

7. (canceled)

8. (canceled)
